(19) United States
(12) Patent Application Publication
(10) Pub. No.: US 2009/0027503 A1
(43) Pub. Date: Jan. 29, 2009

(54) ERROR DETECTING APPARATUS

(75) Inventor: Kenji Yoshioka, Kanagawa (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/914,419

(22) PCT Filed: May 19, 2006
(86) PCT No.: PCT/JP2006/309997

§ 371 Date: Nov. 14, 2007

(30) Foreign Application Priority Data
May 19, 2005 (JP) 2005-146866

(51) Int. Cl. H04N 17/00

(52) U.S. Cl. 348/180; 348/E17.001

(57) ABSTRACT

An error detecting apparatus can diagnose what is happening with the line through which the image signal is passed, and determine a cause of trouble when the line diagnosed as going out of order. The error detecting apparatus comprises an error detecting circuit for detecting a direct voltage from an output line through which an image signal is outputted to a display apparatus from an image signal outputting apparatus, and a CPU, wherein a zener voltage of a zener diode is within a first range, the CPU is adapted to make a decision that the output line is in the output-line-to-power-line short state when a voltage of a cathode of a zener diode is within the first range, a voltage of the electric potential regulated by a pull-up circuit is within a second range, the CPU is adapted to make a decision that the output line is in the electrically-disconnected state when the voltage of the output line is within the second range, an output voltage of a smoothing circuit is within a third range, the CPU is adapted to make a decision that the output line is in the normal state when the output voltage of the smoothing circuit is within the third range, a reference potential defined by a ground line is within a fourth range, the CPU is adapted to make a decision that the output line is in the output-line-to-ground-line short state.

### TECHNICAL FIELD OF THE INVENTION

This invention relates to an error detecting apparatus for detecting whether or not an image signal is being normally passed through a line.

### DESCRIPTION OF THE RELATED ART

Up until now, there have been proposed a wide variety of error detecting apparatuses of this type, one typical example of which is disclosed in a patent document 1. The above-mentioned error detecting apparatus is adapted to judge whether or not parallel lines go out of order by judging whether or not parallel signals are being normally passed through the parallel lines as a coded image signal, and to make a decision that the parallel lines go out of order when at least one of the parallel lines is electrically-disconnected or short-circuited.

Patent document 1: Jpn. unexamined patent publication No. H08-19007

### DISCLOSURE OF THE INVENTION

### Problems to be Solved by the Invention

The conventional error detecting apparatus, however, encounters such a problem that, even if those lines is diagnosed as going out of order, the conventional error detecting apparatus cannot diagnose which line is electrically-disconnected, or short-circuited.

It is, therefore, an object of the present invention to provide an error detecting apparatus that can diagnose what is happening with the line through which the image signal is passed.

### Means for Solving the Problems

The error detecting apparatus according to the present invention comprises: line condition judging means for judging, on the basis of a direct voltage obtained from an output line through which an image signal is outputted to a display apparatus from an image signal outputting apparatus, whether or not the output line is in a normal state, whether or not the output line is in an electrically-disconnected state, whether or not the output line is in an output-line-to-power-line short state, and whether or not the output line is in an output-line- to-ground-line short state.

The error detecting apparatus thus constructed as previously mentioned can diagnose the output line, and determine a cause of its trouble by reason that the judgment is made, on the basis of an electric potential of an output line through which an image signal is outputted to a display apparatus from an image signal outputting apparatus, whether or not the output line is in a normal state, whether or not the output line is in an electrically-disconnected state, whether or not the output line is in an output-line-to-power-line short state, and whether or not the output line is in an output-line-to-ground-line short state.

The line condition judging means may include a zener diode having a cathode corresponding to the output line, and an anode electrically connected to a ground line. The line condition judging means may be adapted to make a decision that the output line is in the output-line-to-power-line short state when an electric potential of the cathode is the same as a zener voltage defined by the zener diode, or within predefined limits.

The line condition judging means may include a pull-up circuit for regulating an electric potential of the output line by intervening between the output line and a power line. The line condition judging means may be adapted to make a decision that the output line is in the electrically-disconnected state when the regulated electric potential of the output line is within predefined limits.

The line condition judging means may include a smoothing circuit for smoothing the image signal. The line condition judging means may be adapted to make a decision that the output line is in the normal state when an output voltage of the smoothing circuit is within predefined limits.

The line condition judging means may be adapted to make a decision that the output line is in the output-line-to-ground-line short state when the electric potential of the output line is the same as a reference potential of a ground line, or within predefined limits.

### ADVANTAGEOUS EFFECT OF THE INVENTION

The present invention has an advantageous effect of diagnosing what is happening with the line through which the image signal is passed, and determine a cause of its trouble when the line diagnosed as going out of order.

### BRIEF DESCRIPTION OF THE DRAWINGS

FIG. 1 is a block diagram showing an image signal processing apparatus provided with an error detecting apparatus according to the embodiment of the present invention.

FIG. 2 is a circuit diagram showing, as an example, a circuit constituted as the error detecting apparatus according to the embodiment of the present invention.

### EXPLANATION OF THE REFERENCE NUMERALS

1: image signal processing apparatus
2: camera
3: external apparatus for outputting an image signal
4: display apparatus
10: CPU
11: diagnosis apparatus
12: first image signal buffer
13: sync separation circuit
14: video processing apparatus
15: second image signal buffer
16: image signal selecting switch
17: video amplifier
18: DRAM
19: flash memory
20: diagnosis memory
30: amplifier
R6, R7, R8, and R9: resister
C1, C2, and C3: capacitor
D1, D2, D3, and D4: diode
ZD: zener diode

### DESCRIPTION OF THE PREFERRED EMBODIMENTS

The embodiment of the error detecting apparatus according to the present invention will be described hereinafter with reference to accompanying drawings. The following description will be directed to the error detecting apparatus forming part of an in-vehicle image signal processing apparatus for receive an image signal from a camera, a picture receiver, or other external apparatus, and outputting the image signal to a display apparatus.

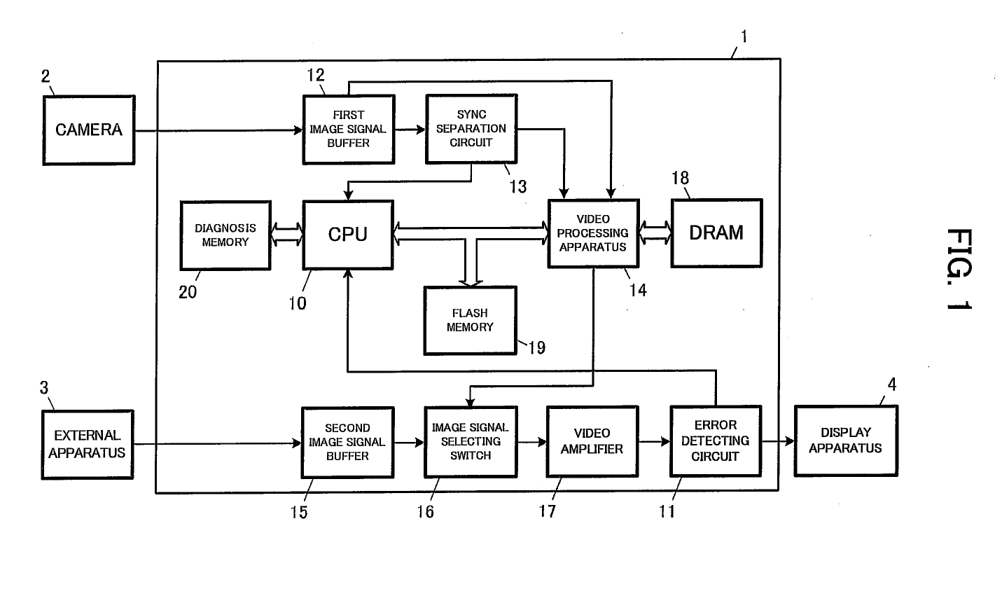

FIG. 1 is a block diagram showing an image signal processing apparatus provided with an error detecting apparatus according to the embodiment of the present invention.

The image signal processing apparatus 1 is electrically connected to a camera 2 for taking an image of an object behind an automotive vehicle, a navigation apparatus, an external apparatus 3 such as for example a television and a digital versatile disc (DVD) player, the external apparatus 3 being adapted to output an image signal to the image signal processing apparatus 1, and a display apparatus 4 for displaying an image represented by an image signal processed by the image signal processing apparatus 1.

The camera 2 includes a lens unit for providing an image of an object, and a charge-coupled device (CCD) for producing an image signal indicative of the image. Here, the image signal may be exemplified by a composite video signal, a RGB signal, a YUV signal, or a signal based on another format.

The display apparatus 4 has a screen, and constituted by a cathode ray tube, a liquid crystal display device or the like. The display apparatus 4 is adapted to display the image on the screen.

The image signal processing apparatus 1 comprises a central processing unit (CPU) 10, a first image signal buffer 12 for buffering the image signal received from the camera 2, a sync separation circuit 13 for obtaining a sync signal from the image signal received from the camera 2, an video processing apparatus 14 for processing the image signal, a second image signal buffer 15 for buffering the image signal received from the external apparatus 3, an image signal selecting switch 16 for selectively outputting the image signal processed by the video processing apparatus 14 and the image signal received from the external apparatus 3, a video amplifier 17 for amplifying the image signal received from the image signal selecting switch 16, and outputting the amplified image signal to the display apparatus 4 through an output line, an error detecting circuit 11 for judging whether or not the image signal is being normally outputted to the display apparatus 4 from the video amplifier 17 through the output line, a dynamic random access memory (DRAM) 18, a flash memory 19, a diagnosis memory 20 for storing, as diagnosis information, the judgment made by the error detecting circuit 11, and a power supply unit (not shown) for supplying an electric power to each part of the image signal processing apparatus 1 and the camera 2.

When the output line is diagnosed as being in “normal state”, the image signal is being normally outputted to the display apparatus 4 through the output line. When the output line is diagnosed as being in “electrically-disconnected state”, the image signal processing apparatus 1 is not being electrically connected to the display apparatus 4 through the output line without normally outputting the image signal to the display apparatus 4. When the output line is diagnosed as being in “output-line-to-power-line short state”, the output line is being directly connected to a power line, and equal in electric potential to the power line. When the output line is diagnosed as being in “output-line-to-ground-line short state”, the output line is directly connected to a ground line, and equal in electric potential to the ground line.

The CPU 10 is adapted to load a program stored in a read only memory (not shown) into the DRAM 18, and to control the video processing apparatus 14, the image signal selecting switch 16, the power supply unit, and the like by executing the program loaded into the DRAM 18.

The first image signal buffer 12 is adapted to buffer the image signal received from the camera 2, and to regulate its pedestal (as a standard of brightness).

The sync separation circuit 13 is adapted to obtain a sync signal from the image signal buffered by the first image signal buffer 12, while the CPU 10 is adapted to monitor the period of the sync signal obtained by the sync separation circuit 13, to judge whether or not the period of the sync signal is within predetermined limits, and to make a decision that the output line is not in the normal state when the sync signal is not within the limits.

The video processing apparatus 14 is constituted by a digital signal processing apparatus such as for example an image processor, while the CPU 10 is adapted to have the video processing apparatus 14 perform overhead-view processing of the image signal buffered by the first image signal buffer 12, and perform superimposing processing of support information.

More specifically, the CPU 10 is adapted to compensate the distortion of the image taken at short range by performing the overhead-view processing, and to produce an image equivalent to a view from a position above the level of the camera 2, the object being close to a bumper or other part of the automotive vehicle, and to superimpose support information on the image by performing the superimposing processing of the support information, the support information including information on a traveling direction of the automotive vehicle, a distance between the object and the automotive vehicle, and the like.

The second image signal buffer 15 is adapted to buffer the image signal received from the external apparatus 3, and to regulate its pedestal (as a standard of brightness).

The CPU 10 is adapted to have the image signal selecting switch 16 selectively output the image signal processed by the video processing apparatus 14 and the image signal received from the external apparatus 3 to the video amplifier 17.

The video amplifier 17 is adapted to amplify the image signal received from the image signal selecting switch 16 to ensure that the amplified image signal meets the requirements of the display apparatus 4.

The error detecting circuit 11 and the CPU 10 are collectively constituted as line condition judging means of the error detecting apparatus according to the present invention. The error detecting circuit 11 includes capacitors C1 to C3, an amplifier 30, resisters R6 to R9, diodes D1 and D2, and a zener diode ZD.

The capacitor C1 has one end electrically connected to an output terminal of the video amplifier 17, and the other end electrically connected to an input terminal of the amplifier 30. The resister R6 has one end electrically connected to an output terminal of the amplifier 30, and the other end electrically connected to one end of the capacitor C2.

The diode D1 has a cathode electrically connected to the other end of the capacitor C2, an anode grounded. The capacitor C2 and the diode D1 are collectively constituted as a smoothing circuit. The diode D2 has an anode electrically connected to the other end of the capacitor C2, i.e., an output terminal of the smooth circuit.

The resister R7 has one end electrically connected to the output terminal of the video amplifier 17, and the other end electrically connected to the anode of the diode D3. The zener diode ZD has a cathode electrically connected to the other end of the resister R7, and an anode grounded. When the output line is in the output-line-to-power-line short state, the zener diode ZD is adapted to prevent the CPU 10 from giving rise to a latch-up phenomenon by preventing a voltage larger than a zener voltage of the zener diode ZD from being applied to the CPU 10.

The diodes D2 and D3 have respective cathodes electrically connected to each other, and electrically connected to the CPU 10. The diodes D2 and D3 collectively constitute a logical OR operation circuit. Each of the capacitor C3 and the resister R9 has one end electrically connected to the cathodes of the diodes D2 and D3, and the other end grounded.

The output terminal of the video amplifier 17 is electrically connected to an input terminal of the display apparatus 4 through the output line regulated in electric potential by a pull-up circuit including a diode D4 and a register R8. The diode D4 has a cathode electrically connected to the power line and an anode electrically connected to one end of the resister R8.

As shown in FIG. 1, the DRAM 18 is electrically connected to the video processing apparatus 14, and has, in addition to the program to be executed by the CPU 10, temporary data to be used in a processing stage by the video processing apparatus 14. The flash memory 19 is electrically connected to the video processing apparatus 14, and has parameter and the like to be used by the video processing apparatus 14.

The diagnosis memory 20 is constituted by a nonvolatile memory medium such as for example an electrically erasable programmable read-only memory (EEPROM). The CPU 10 is adapted to store diagnostic information in the diagnosis memory 20. The diagnostic information includes, as current and previous diagnosis records, time, condition detected at each time, and the like.

The CPU 10 is adapted to output the diagnostic information stored in the diagnosis memory 20 to an interface circuit (not shown) for performing communication with a removable memory medium, or another apparatus.

The CPU 10 is adapted to have the power supply unit adjust the electric potential of the power line by stepping up or stepping down a supply voltage of a power source of the automotive vehicle, to have the power supply unit supply an electric power to each part of the image signal processing apparatus 1 and camera 2 through the power line. In order to prevent the CPU 10 or the camera 2 from falling into a latch-up state, the power supply unit is adapted not to supply the electric power to the CPU 10 and the camera 2 when the CPU 10 is not active.

The operation of the image signal processing apparatus 1 thus constructed will be then described hereinafter.

When a driver firstly turns on an ignition power source and an accessory power source of the automotive vehicle, the power supply unit supplies an electric power to each part of the image signal processing apparatus 1 to allow each part of the image signal processing apparatus 1 to be in an active state.

When a driver does not need the image of the object behind the automotive vehicle, for example, the automotive vehicle is not in a reverse gear, the image signal received from the external apparatus 3 is selected by the image signal selecting switch 16. The image signal received from the external apparatus 3 is inputted into the video amplifier 17 through the second image signal buffer 15 and the image signal selecting switch 16.

When, on the other hand, the driver needs the image of the object behind the automotive vehicle, for example, the automotive vehicle is in the reverse gear, the electric power is supplied to the camera 2 from the power supply unit in order to turn on the camera. The image signal processed by the video processing apparatus 14 is selected by the image signal selecting switch 16. The image signal received from the external apparatus 3 is inputted into the video amplifier 17 through the second image signal buffer 15 and the image signal selecting switch 16.

The image signal received from the camera 2 is inputted into the video processing apparatus 14 through the first image signal buffer 12. The image signal received from the first image signal buffer 12 is then processed by the video processing apparatus 14. The image signal processed by the video processing apparatus 14 is then outputted to the video amplifier 17 through the image signal selecting switch 16.

The image signal is received from the image signal selecting switch 16 by the video amplifier 17, amplified by the video amplifier 17, and outputted to the display apparatus 4. The image represented by the amplified image signal is then displayed on the screen by the display apparatus.

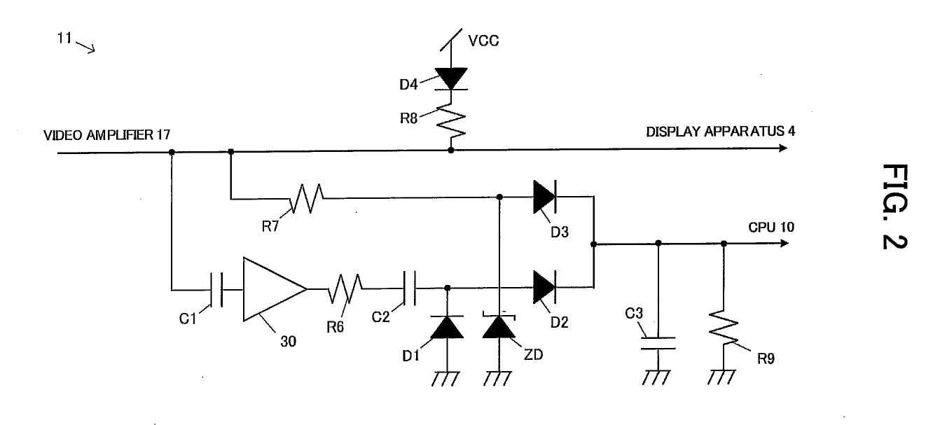

The operation of the error detecting circuit 11 will be then described hereinafter with reference to FIG. 2. In this embodiment, a direct voltage “VCC” of the power line to the ground line is equal to 3.3 [volt], and a forward voltage drop “Vd” of the diode D4 is equal to 0.6 [volt]. The resisters R6, R7, R8, and R9 have respective resistances of 1 [kilo ohm], 4.7 [kilo ohm], 22 [kilo ohm], and 100 [kilo ohm]. The capacitors C1, C2, and C3 have respective capacitances of 1 [micro farad], 2.2 [micro farad], and 1 [micro farad].

When the output line is in the output-line-to-power-line short state, the electric potential of the anode of the diode D3 to the ground line is suppressed to 3.3 [volt] by the zener diode ZD in this embodiment.

From the foregoing description, it will be understood that the potential difference suppressed to 3.3 [volt] is inputted into the CPU 10 when the output line is in the output-line-to-power-line shout state.

When the in-vehicle image signal processing apparatus 1 is being electrically-disconnected to the display apparatus 4 without normally outputting the image signal to the display apparatus 4, a voltage corresponding to the register R9 is given by a follow equation by reason that the pull-up circuit intervenes between the output line and the power line, and includes a diode D4 and a resister R8, and a voltage difference between the direct voltage “VCC” and the forward voltage drop “Vd” is being divided by the resisters R7, R8, and R9.

(VCC−Vd)×R9÷(R7+R8+R9)≈2.1 [volt]

From the foregoing description, it will be understood that the image signal suppressed to 2.1 [volt] is inputted into the CPU 10 when the output line is in the electrically-disconnected state.

When the image signal is being normally outputted to the display device 4 through the output line, the voltage to be detected by the CPU 10 is dependent on a signal outputted from the amplifier 30, and hardly affected by other elements (such as a pull-up circuit for regulating in electric potential the output line) by reason that the display apparatus 4 has an input impedance of 75 [ohm], and electrically connected to the video amplifier 17 through the output line.

Here, the amplifier 30 has a gain to be adjusted on the basis of a median of the image signal smoothed by a smoothing circuit (constituted by the capacitor C2 and the diode D1). The amplifier 30 is adapted to amplify the image signal according to the adjusted gain to ensure that the median of the smoothed image signal is approximately equal to 1 [volt].

From the foregoing description, it will be understood that the image signal suppressed to about 1 [volt] is inputted into the CPU 10 when the output line is in the normal state.

When the output line is in the output-line-to-ground-line short state, the image signal is suppressed to zero [volt], i.e., a reference potential. Accordingly, the image signal suppressed to zero [volt] is inputted into the CPU 10.

From the foregoing description, it will be understood that the CPU 10 can make a decision that the output line is in the output-line-to-power-line short state when the voltage obtained from the error detecting circuit 11 is no less than 2.7 [volt], make a decision that the output line is in the electrically-disconnected state when the voltage obtained from the error detecting circuit 11 is smaller than 2.7 [volt], and no less than 1.6 [volt], make a decision that the output line is in the normal state when the voltage obtained from the error detecting circuit 11 is smaller than 1.6 [volt], and no less than 0.5 [volt], and make a decision that the output line is in the output-line-to-ground-line short state when the voltage obtained from the error detecting circuit 11 is smaller than 0.5 [volt].

From the foregoing description, it will be understood that the image signal processing apparatus 1 according to the embodiment of the present invention can obtain, when the output line goes out of order, diagnosis outcome such as a cause of trouble from the error detecting apparatus 11 by reason that the error detecting apparatus 11 is adapted to judge, on the basis of the voltage obtained from the error detecting circuit 11 by the CPU 10, whether or not the line is in the normal state, whether or not the line is in the electrically-disconnected state, whether or not the line is in the output-line-to-power-line short state, and whether or not the line is in the output-line-to-ground-line short state, and determine a cause of trouble when the line diagnosed as going out of order.

### INDUSTRIAL APPLICABILITY OF THE PRESENT INVENTION

As will be seen from the foregoing description, the error detecting apparatus according to the present invention has an advantageous effect of monitoring the line through which the image signal is passing, and diagnosing what is happening with the line. The error detecting apparatus according to the present invention is useful as, for example, an apparatus for determining a cause of trouble when the line diagnosed as going out of order.

What is claimed is:

1. An error detecting apparatus, comprising: line condition judging means for judging, on the basis of a direct voltage obtained from an output line through which an image signal is outputted to a display apparatus from an image signal outputting apparatus, whether or not said output line is in a normal state, whether or not said output line is in an electrically-disconnected state, whether or not said output line is in an output-line-to-power-line short state, and whether or not said output line is in an output-line-to-ground-line short state.

2. An error detecting apparatus as set forth in claim 1, in which said line condition judging means includes a zener diode having a cathode corresponding to said output line, and an anode electrically connected to a ground line, and in which
said line condition judging means is adapted to make a decision that said output line is in said output-line-to-power-line short state when an electric potential of said cathode is the same as a zener voltage defined by said zener diode, or within predefined limits.

3. An error detecting apparatus as set forth in claim 1, in which said line condition judging means includes a pull-up circuit for regulating an electric potential of said output line by intervening between said output line and a power line, and in which
said line condition judging means is adapted to make a decision that said output line is in said electrically-disconnected state when said regulated electric potential of said output line is within predefined limits.

4. An error detecting apparatus as set forth in claim 1, in which said line condition judging means includes a smoothing circuit for smoothing said image signal, and in which
said line condition judging means is adapted to make a decision that said output line is in said normal state when an output voltage of said smoothing circuit is within predefined limits.

5. An error detecting apparatus as set forth in claim 1, in which said line condition judging means is adapted to make a decision that said output line is in said output-line-to-ground-line short state when said electric potential of said output line is the same as a reference potential of a ground line, or within predefined limits.

6. An error detecting apparatus, comprising: line condition judging means for judging, on the basis of an electric potential of an output line through which an image signal is outputted to a display apparatus from an image signal outputting apparatus, whether or not said output line is in a normal state, whether or not said output line is in an electrically-disconnected state, whether or not said output line is in an output-line-to-power-line short state, and whether or not said output line is in an output-line-to-ground-line short state, wherein
said line condition judging means includes a zener diode having a cathode corresponding to said output line, and an anode electrically connected to a ground line, a zener voltage of said zener diode being within a first range, a pull-up circuit for regulating an electric potential of said output line by intervening between said output line and a power line, and a smoothing circuit for smoothing said image signal,
said line condition judging means is adapted to make a decision that said output line is in said output-line-to-power-line short state when an electric potential of said cathode is the same as a zener voltage defined by said zener diode, or within predefined limits,
said line condition judging means is adapted to make a decision that said output line is in said electrically-disconnected state when said regulated electric potential of said output line is within predefined limits,
said line condition judging means is adapted to make a decision that said output line is in said normal state when an output voltage of said smoothing circuit is within predefined limits, and
said line condition judging means is adapted to make a decision that said output line is in said output-line-to-ground-line short state when said image signal is the same as a reference potential of said ground line, or within predefined limits.

7. A video system, comprising:
an image signal outputting apparatus for outputting an image signal;
a display apparatus for displaying an image represented by said image signal; and
an image signal processing apparatus for allowing said display apparatus to display said image on a screen, said image being represented by said image signal received from said image signal outputting apparatus, wherein
said image signal processing apparatus has line condition judging means for judging, on the basis of an electric potential of an output line through which an image signal is outputted to a display apparatus from an image signal outputting apparatus, whether or not said output line is in a normal state, whether or not said output line is in an electrically-disconnected state, whether or not said output line is in an output-line-to-power-line short state, and whether or not said output line is in an output-line-to-ground-line short state.
